(19) United States
(12) Patent Application Publication
(10) Pub. No.: US 2026/0169715 A1
(43) Pub. Date: Jun. 18, 2026

(54) CACHING LAYERS OF AN IMAGE TO DEPLOY AT NODES IN A CLUSTER

(71) Applicant: INTERNATIONAL BUSINESS MACHINES CORPORATION, ARMONK, NY (US)

(72) Inventors: Paritosh RANJAN, Kolkata (IN); Bhubaneswar PADHAN, KOLKATA (IN); Prodip ROY, Kolkata (IN)

(21) Appl. No.: 18/986,189

(22) Filed: Dec. 18, 2024

(51) Int. Cl. G06F 8/61

(52) U.S. Cl. CPC G06F 8/61

(57) ABSTRACT

Provided are a computer implemented method, system, and computer program product for caching layers of an image to deploy at nodes in a cluster. Information on an image is analyzed to determine layers that form the image. A determination is made, from a local registry file, of local layers in the image stored in a local registry that are determined to be frequently accessed layers. Remote layers in the image that are not stored in the local registry are downloaded from a remote registry over a network. The image is built from the remote layers and the local layers. The built image is deployed on the node.

### BACKGROUND OF THE INVENTION

### 1. Field of the Invention

The present invention relates to a computer implemented method, system, and computer program product for caching layers of an image to deploy at nodes in a cluster.

### 2. Description of the Related Art

In a Kubernetes network, a cluster comprises a plurality of host nodes, each capable of running one or more pods in which applications and containers run. Host nodes in a cluster communicate over a network infrastructure. Edge Kubernetes clusters comprise nodes deployed at an edge location of the network. The edge cluster may download images of executable code from cloud providers to deploy at the nodes in the edge cluster.

### SUMMARY

Provided are a computer implemented method, system, and computer program product for caching layers of an image to deploy at nodes in a cluster. Information on an image is analyzed to determine layers that form the image. A determination is made, from a local registry file, of local layers in the image stored in a local registry that are determined to be frequently accessed layers. Remote layers in the image that are not stored in the local registry are downloaded from a remote registry over a network. The image is built from the remote layers and the local layers. The built image is deployed on the node.

### BRIEF DESCRIPTION OF THE DRAWINGS

FIG. 1 illustrates an embodiment of an edge cluster of nodes.

FIG. 2 illustrates an embodiment of a registry file entry of an entry in a registry file for layers stored in a local registry.

FIG. 3 illustrates an embodiment of a layer information entry having information on a layer downloaded from a remote registry.

FIG. 4 illustrates an embodiment of operations to build an image for nodes in an edge cluster from remote layers and local layers.

FIG. 5 illustrates an embodiment of operations to manage the layers maintained in the local registry.

FIG. 6 illustrates a computing environment in which the components of FIG. 1 may be implemented.

### DETAILED DESCRIPTION

Edge clusters of nodes, such as edge Kubernetes clusters, have limited network bandwidth due to their edge location far from major data centers. Downloading all images, such as docker images, deployed in an edge Kubernetes cluster at the time of cluster upgrades or node reloads may consume substantial network bandwidth and increase latency of pod/container deployment at the nodes in the cluster.

Described embodiments provide improvements to computer technology for downloading images to deploy at nodes at a cluster, such as an edge cluster. In described embodiments, layers of an image to deploy at nodes in a cluster are downloaded from a remote cloud location. The same layers may be repeated in multiple images downloaded to deploy at the nodes. Layer information is maintained indicating access frequency of the layers in being used in different image builds to deploy at the cluster nodes. The layer information on layer access and utilization in different images is used to determine which downloaded layers to maintain in a local registry. Images to deploy on the cluster nodes may be built from local layers maintained in the local registry and remote layers downloaded from a remote registry, such as within a cloud platform. Using the local registry reduces latency to build images from layers by locally caching the more frequently accessed layers to use in subsequent image builds.

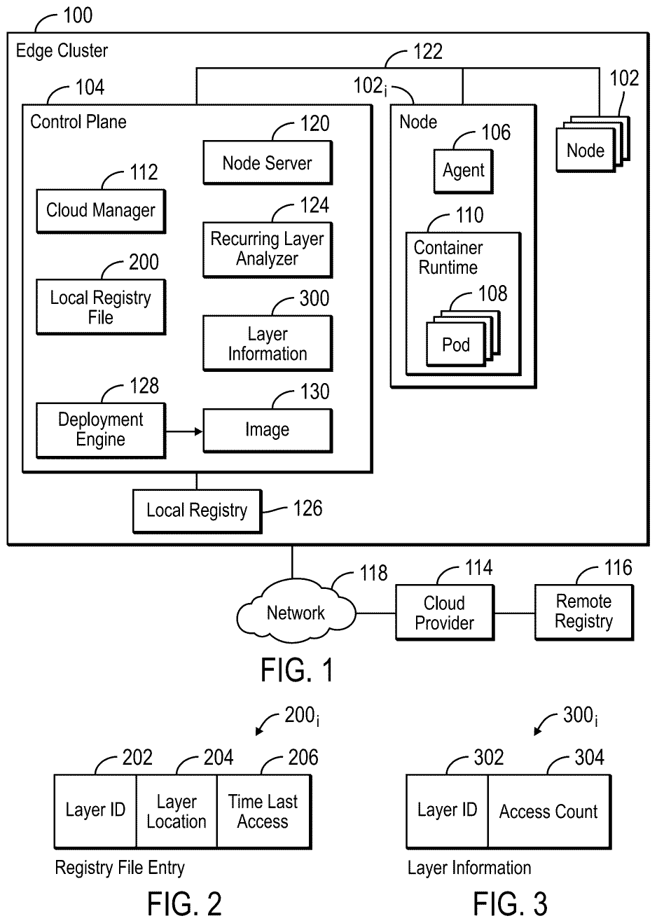

FIG. 1 illustrates an embodiment of an edge cluster 100 having a plurality of nodes 102ᵢ and 102₂ and a control plane 104 having the components that manage the nodes 102, including representative node 102ᵢ showing components in a node. In certain embodiments, the edge cluster 100 may comprise a Kubernetes edge cluster or a non-edge cluster. The nodes 102 may comprise Internet of Things (IoT) devices, virtual machines, physical machines, etc. Each host node 102ᵢ includes an agent 106, such as a node kubelet in a Kubernetes environment, to manage containers running in pods 108 in a container runtime 110. The container runtime manages execution and lifecycle of containers.

The term “pod” as used herein refers to a smallest deployable unit of computing that can be created and managed in the network environment. A pod 108 may refer to a deployable unit of computing in which containers execute and may also refer to a container. Pods 108 comprise program environments that host and manage and execute containers that run applications. A container includes libraries, dependencies, and other resources necessary for an application to function independently. A pod 108 provides a wrapper with dependencies to allow management of containers that run in the pod 108. The nodes 102 comprises a physical or virtual machine that hosts one or more pods 108, each pod having one or more containers. The control plane 104 controls pod scheduling and placement. There may be thousands of nodes in a cluster 100, each having many pods that run different configurations.

An image comprises binary data that encapsulates an application and all its software dependencies. Container images are executable software bundles that can run standalone and that make very well-defined assumptions about their runtime environment. A container image is implemented in the pods 108.

The control plane 104 includes a cloud manager 112 to access images in a cloud provider 114 remote registry 116 over a network 118; a node server 120, such as a Kube server in a Kubernetes environment, to manage communications with the nodes 102 over an internal network 122 in the cluster 100; a recurring layer analyzer 124 to analyze layers for images downloaded from a remote registry 116 to determine whether to store locally in a local registry 126; a local registry file 200 having information on layers maintained in in the local registry 126; layer information 300 having information on layers downloaded from the remote registry 116; and a deployment engine 128 to build the image 130 from layers downloaded from the remote registry 116 and from layers in the local registry file 200.

FIG. 2 illustrates an embodiment of an entry 200ᵢ in the local registry file 200, including: a layer identifier (ID) 202 identifying the layer, which may comprise a signature of the layer; a layer location 204 in the local registry 126 of the layer; and a time of last access 206 of the layer to include in an image 130.

FIG. 3 illustrates an embodiment of an entry 300ᵢ in the layer information 300, including a layer ID 302 and an access count 304 indicating a number of time the layer 302 was accessed to include in an image 130.

Although certain embodiments of the cluster 100 are described in a Kubernetes environment, the edge cluster may be implemented in other node and IoT networking technologies and environments.

The program components of FIG. 1, including components 106, 108, 110, 112, 120, 124, 128, 130, may comprise program code loaded into a memory and executed by one or more processors. Alternatively, some or all of the functions may be implemented as microcode or firmware in hardware devices, such as in Application Specific Integrated Circuits (ASICs), Field Programmable Gate Arrays (FPGAs), etc.

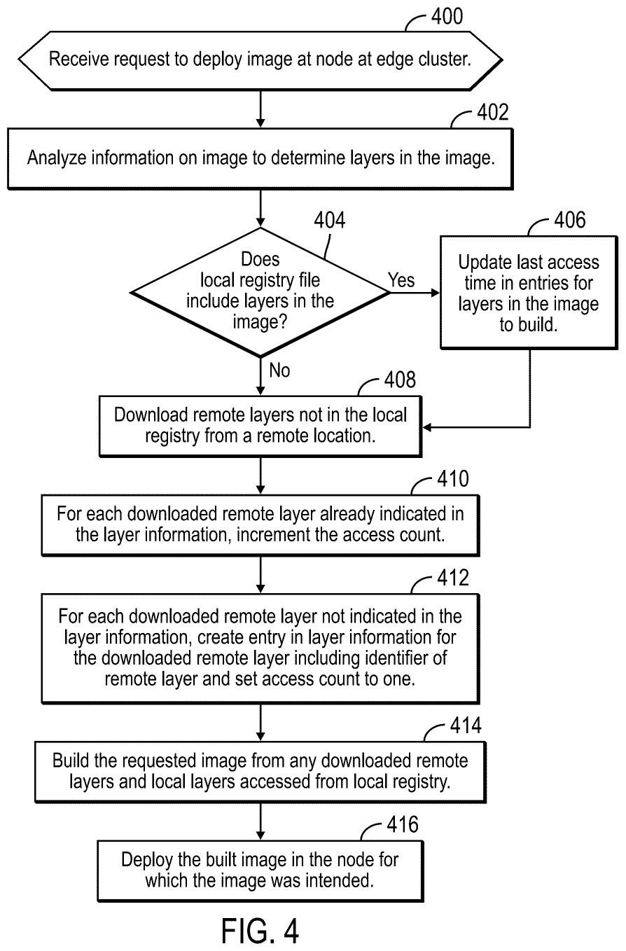

FIG. 4 illustrates an embodiment of operations performed by components in the control plane 104 to build an image 130 to deploy to the nodes 102. A request is received (at block 400) to deploy an image to a node in the edge cluster, which may comprise a push request from a remote server or a pull request from the control plane. The recurring layer analyzer, such as 124, may analyze (at block 402) information on the image to deploy to determine layers in the image. If (at block 404) the local registry file 200 has entries 200ᵢ for layers in the image, then the last access time 206 is updated (at block 406) in the entries 200ᵢ for layers in the image to build to a current time. From block 406 or from the NO branch of block 404, the cloud manager 112 downloads (at block 408) remote layers not in the local registry 126, i.e., no registry file entry 200ᵢ for the layer. Inc certain embodiments, the operations at blocks 402 and 404 of analyzing information on the image to determine the layers and determining the layers in the local registry are performed without downloading the image. Only if the image is not found in the local registry, are remote layers downloaded from the remote location.

For each downloaded remote layer indicated in an entry 300ᵢ in the layer information 300, the recurring layer analyzer 124 increments (at block 410) the access count 304 in the entry 300ᵢ. For each downloaded remote layer not indicated in an entry 300ᵢ in the layer information 300, the recurring layer analyzer 124 or other component creates (at block 412) an entry 300ᵢ in the layer information 300 for the downloaded remote layer including an identifier 302 of the remote layer and sets an access count 304 in the entry to one. The deployment engine 128 may build (at block 414) the image 130 from the local layers accessed from the local registry 126 and/or downloaded remote layers. The built image 130 is deployed (at block 416) at the nodes for which the image was intended, either pulled by a node or pushed by a remote cloud provider.

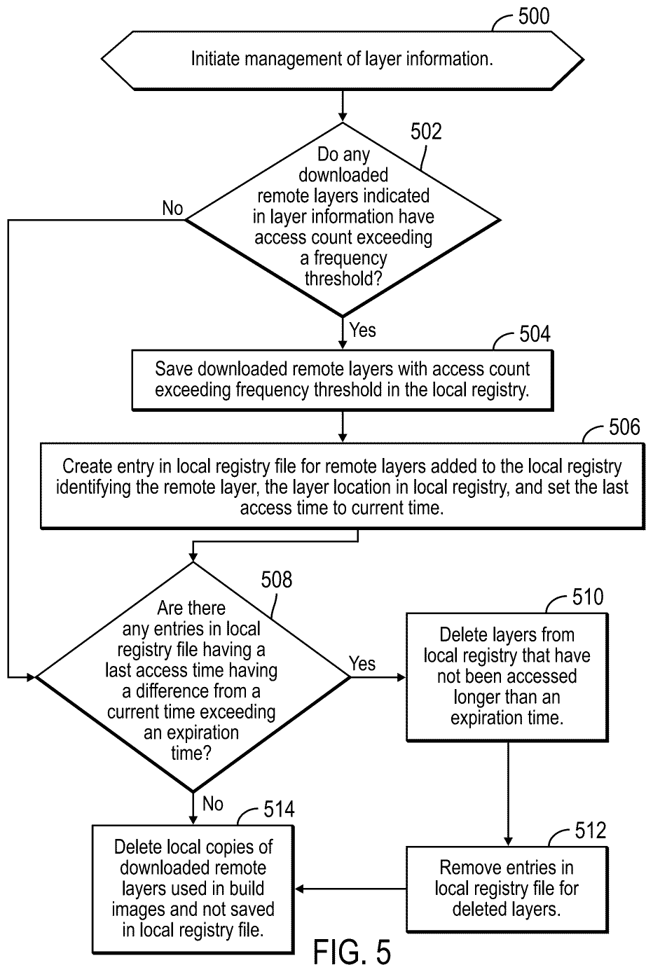

FIG. 5 illustrates an embodiment of operations performed by a component in the control plane 104, such as the recurring layer analyzer 124, to determine whether to save downloaded layers in the local registry and to determine whether to expire layers from the local registry to free space for more frequently and currently accessed layers. Upon initiating (at block 500) management of layer information, if (at block 502) any downloaded remote layers indicated in the layer information 300 have an access count 304 exceeding a frequency threshold, those frequently accessed downloaded remote layers are saved (at block 504) in the local registry. An entry is created (at block 504) in the local registry file for each of the remote layers added to the local registry identifying the remote layer, the layer location in local registry, and a last access time is set to a current time. From block 506 or the NO branch of block 502, a determination is made (at block 508) of any entries in the local registry file having a last access time 206 that differs from the current time by more than an expiration time. Layers stored in the local registry that have not been accessed within the expiration time comprise infrequently accessed layers that may be removed from the local registry as they are not being sufficiently reused. If (from the YES branch of block 508) there are local registry file entries that have not been accessed within an expiration time, then layers for those determined entries are deleted (at block 510) from the local registry. The local registry entries for those deleted layers are removed (at block 512) from the local registry file. From block 512 or the NO branch of block 508, local copies of the downloaded remote layers used in built images that were not saved in the local registry are deleted (at block 514).

With the embodiment of FIGS. 4 and 5, the time to build and deploy an image is optimized by retaining frequently accessed layers that may be included in an image in a local registry. Only remote layers not in the local registry need to be downloaded from a cloud provider when building an image to deploy at the nodes. Further, access counts are maintained for layers previously downloaded but not yet stored in the local registry to determine when to add a layer to the local registry. If the access count for a layer in the layer information does not exceed the threshold, then the entry in the layer information for that layer maintains the access count for the layer. The layer indicated in the layer information may be discarded because its access count is not greater than the threshold at which layers are stored in the local registry. This improves the access time to access layers by only storing in the local registry the most frequently accessed layers used to build images to deploy at edge nodes. Yet further, layers in the local registry that have not been used in a built image for an expiration time are expired and removed from the local registry to free space for more recently downloaded and frequently accessed layers, which are also more likely to be included in subsequent image builds.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts and description, when there is a condition with different operations described as performed depending on the result of the condition, all results of the condition may occur at different times resulting in the different operations performed for the different results of the condition at different times.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

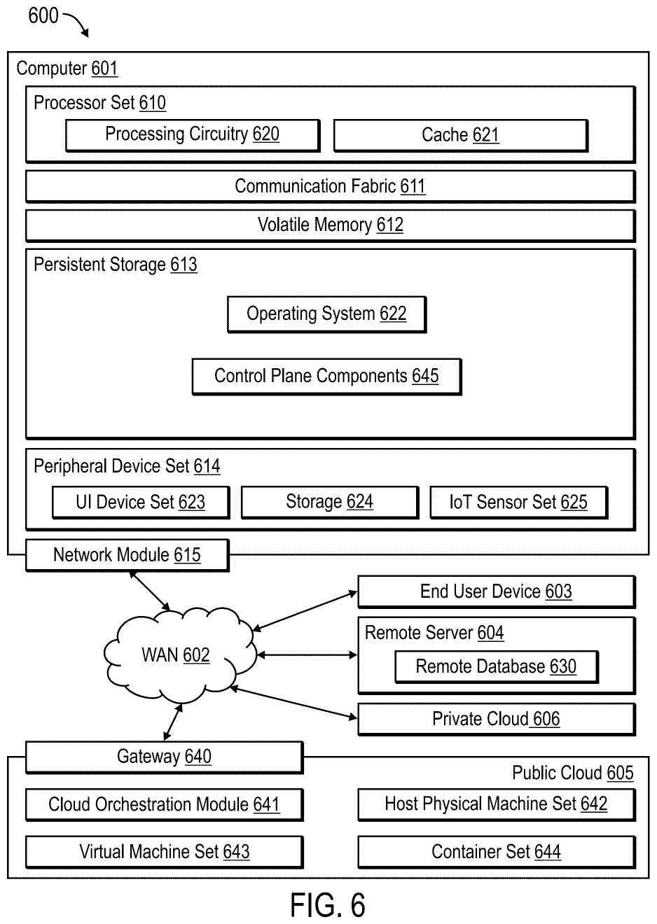

With respect to FIG. 6, computing environment 600 contains an example of an environment for the execution of at least some of the computer code involved in performing the inventive methods, such as the operations to maintain common layers from images in a local registry, including maintaining control plane components 645. The control plane components 645 may include the cloud manager 112, node server 120, recurring layer analyzer 124, and deployment engine 128 described with respect to FIG. 1. In addition to block 645, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 200, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer-readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 645 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 645 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector. In certain embodiments, the peripheral device set 614 may comprise the nodes 102 in the edge cluster 100.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer-readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

CLOUD COMPUTING SERVICES AND/OR MICROSERVICES (not separately shown in FIG. 6): private and public clouds 606 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for downloading executable images to deploy at nodes in a network, comprising:
analyzing information on an image to determine layers that form the image;
determining, from a local registry file, local layers in the image stored in a local registry that are determined to be frequently accessed layers;
downloading, from a remote registry over a network, remote layers in the image that are not stored in the local registry;
building the image from the remote layers and the local layers; and
deploying the built image on the node.

2. The computer implemented method of claim 1, wherein the nodes are part of an edge computing cluster, wherein the local registry is in the edge computing cluster, wherein images built from remote layers and local layers are deployed at the nodes in the edge computing cluster, and wherein the remote registry is external to the edge computing cluster over a network.

3. The computer implemented method of claim 1, wherein the analyzing information on the image to determine the layers and the determining the layers in the local registry and the remote registry are performed without downloading the image.

4. The computer implemented method of claim 1, further comprising:
determining a frequently accessed layer of the remote layers having an access frequency exceeding a threshold access frequency;
storing the frequently accessed layer in the local registry; and
indicating the frequently accessed layer in the local registry file.

5. The computer implemented method of claim 1, further comprising:
maintaining an access count for a remote layer downloaded from the remote registry;
incrementing the access count in response to a download of the remote layer to include in the image to build;
determining that the access count does not exceed a frequency threshold; and
discarding the remote layer after building the image in response to the determining that the access count does not exceed the frequency threshold.

6. The computer implemented method of claim 5, further comprising:
incrementing the access count in response to a subsequent download of the remote layer to include in another image to build;
determining that the access count exceeds the frequency threshold in response to the subsequent download; and
including the remote layer in the local registry and indicating the remote layer in the local registry file in response to the determining that the access count exceeds the frequency threshold for the subsequent download.

7. The computer implemented method of claim 1, further comprising:
determining an infrequently accessed local layer in the local registry comprising a local layer that has not been accessed within an expiration time;
removing the infrequently accessed local layer from the local registry; and
updating the local registry file to remove indication of the infrequently accessed local layer.

8. A system for downloading executable images to deploy at nodes in a network, comprising:
a processor; and
a computer readable storage medium having computer readable program code embodied therein that when executed by the processor performs operations, the operations comprising:
analyzing information on an image to determine layers that form the image;
determining, from a local registry file, local layers in the image stored in a local registry that are determined to be frequently accessed layers;
downloading, from a remote registry over a network, remote layers in the image that are not stored in the local registry;
building the image from the remote layers and the local layers; and
deploying the built image on the node.

9. The system of claim 8, wherein the nodes are part of an edge computing cluster, wherein the local registry is in the edge computing cluster, wherein images built from remote layers and local layers are deployed at the nodes in the edge computing cluster, and wherein the remote registry is external to the edge computing cluster over a network.

10. The system of claim 8, wherein the analyzing information on the image to determine the layers and the determining the layers in the local registry and the remote registry are performed without downloading the image.

11. The system of claim 8, wherein the operations further comprise:
determining a frequently accessed layer of the remote layers having an access frequency exceeding a threshold access frequency;
storing the frequently accessed layer in the local registry; and
indicating the frequently accessed layer in the local registry file.

12. The system of claim 8, wherein the operations further comprise:
maintaining an access count for a remote layer downloaded from the remote registry;
incrementing the access count in response to a download of the remote layer to include in the image to build;
determining that the access count does not exceed a frequency threshold; and
discarding the remote layer after building the image in response to the determining that the access count does not exceed the frequency threshold.

13. The system of claim 12, wherein the operations further comprise:
incrementing the access count in response to a subsequent download of the remote layer to include in another image to build;
determining that the access count exceeds the frequency threshold in response to the subsequent download; and
including the remote layer in the local registry and indicating the remote layer in the local registry file in response to the determining that the access count exceeds the frequency threshold for the subsequent download.

14. The system of claim 8, wherein the operations further comprise, further comprising:
determining an infrequently accessed local layer in the local registry comprising a local layer that has not been accessed within an expiration time;
removing the infrequently accessed local layer from the local registry; and
updating the local registry file to remove indication of the infrequently accessed local layer.

15. A computer program product for downloading executable images to deploy at nodes in a network, the computer program product comprising a computer readable storage medium having computer readable program code embodied therein that when executed by a processor performs operations, the operations comprising:
analyzing information on an image to determine layers that form the image;
determining, from a local registry file, local layers in the image stored in a local registry that are determined to be frequently accessed layers;
downloading, from a remote registry over a network, remote layers in the image that are not stored in the local registry;
building the image from the remote layers and the local layers; and
deploying the built image on the node.

16. The computer program product of claim 15, wherein the nodes are part of an edge computing cluster, wherein the local registry is in the edge computing cluster, wherein images built from remote layers and local layers are deployed at the nodes in the edge computing cluster, and wherein the remote registry is external to the edge computing cluster over a network.

17. The computer program product of claim 15, wherein the analyzing information on the image to determine the layers and the determining the layers in the local registry and the remote registry are performed without downloading the image.

18. The computer program product of claim 15, wherein the operations further comprise:
determining a frequently accessed layer of the remote layers having an access frequency exceeding a threshold access frequency;
storing the frequently accessed layer in the local registry; and
indicating the frequently accessed layer in the local registry file.

19. The computer program product of claim 15, wherein the operations further comprise:
maintaining an access count for a remote layer downloaded from the remote registry;
incrementing the access count in response to a download of the remote layer to include in the image to build;
determining that the access count does not exceed a frequency threshold; and
discarding the remote layer after building the image in response to the determining that the access count does not exceed the frequency threshold.

20. The computer program product of claim 19, wherein the operations further comprise:
incrementing the access count in response to a subsequent download of the remote layer to include in another image to build;
determining that the access count exceeds the frequency threshold in response to the subsequent download; and
including the remote layer in the local registry and indicating the remote layer in the local registry file in response to the determining that the access count exceeds the frequency threshold for the subsequent download.
